(19) United States
(12) Patent Application Publication
(10) Pub. No.: US 2023/0021023 A1
(43) Pub. Date: Jan. 19, 2023

(54) PROGRESSIVE API RESPONSES

(71) Applicant: Twitter, Inc., San Francisco, CA (US)

(72) Inventors: John Anthony Debay, Louisville, CO (US); Abdelrahman Asal, San Bruno, CA (US); Amandeep Singh Grewal, Jersey City, NJ (US); Reza Mohamed Ekbal Lotun, San Francisco, CA (US); Nolan O'Brien, Henderson, NV (US)

(21) Appl. No.: 17/953,121

(22) Filed: Sep. 26, 2022

Related U.S. Application Data
(63) Continuation of application No. 16/136,093, filed on Sep. 19, 2018.

(51) Int. Cl. G06F 16/48; G06F 16/38; G06F 16/44; G06F 16/248; G06Q 50/00; G09G 5/395

(52) U.S. Cl. CPC G06F 16/48; G06F 16/38; G06F 16/44; G06F 16/248; G06Q 50/01; G09G 5/395; G06F 16/338

(57) ABSTRACT

Methods, systems, and computer programs encoded on computer storage media, for incrementally receiving and rendering content items. One example system includes a server, a user device, and a client running on the user device. The client sends a content request to the server. The client receives a response to the content request incrementally in multiple fragments. The multiple fragments constitute the entire response. The fragments include content items and metadata describing the content items, and each content item is renderable and defined by one or more data objects. The client incrementally renders the content items in the fragments in a display buffer as the fragments are received. The content items are rendered in an order determined by the metadata. The client displays all or a part of the display buffer on a display of the user device.

### CROSS REFERENCE TO RELATED APPLICATIONS

This application is a continuation of U.S. application Ser. No. 16/136,093, filed Sep. 19, 2018, the contents of which are incorporated by reference herein.

### BACKGROUND

This specification relates to social messaging platforms, and in particular, to technologies for incrementally receiving and rendering fragments of a response to a content request from a social messaging platform.

Social messaging platforms and network-connected personal computing devices allow users to create and share content across multiple devices in real-time.

Popular social messaging platforms generally provide functionality for users to draft and post messages, both synchronously and asynchronously, to other users. Examples of popular social messaging platforms include Facebook, Pinterest, and Twitter. (“Facebook” is a trademark of Facebook, Inc. “Pinterest” is a trademark of Pinterest, Inc. “Twitter” is a trademark of Twitter, Inc.)

Generally, when client software on a computing device sends a content request to a social messaging platform, the client software must wait to receive a full response to the request before presenting any of the response to the user of the device.

### SUMMARY

This specification describes technologies that enable client software to receive and render fragments of a response to a content request from a social messaging platform.

An example system includes a server configured to implement a social messaging platform, a user device, and client software of the social messaging platform running on the user device. The client software is configured to send a content request to the server. The client software receives a response to the content request from the server incrementally in multiple fragments from a transport layer of a network stack on the user device. The multiple fragments constitute the entire response. The response includes content items and metadata describing the content items. Each content item is renderable and defined by one or more data objects. The client software incrementally renders, into a display buffer, the content items in the fragments as the fragments are received. This includes placing the content items in the display buffer in an order determined by the metadata. The display buffer is a data structure in a memory of the user device. The client software then displays all or a part of the display buffer on a display of the user device.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this application can be implemented in particular embodiments so as to realize one or more of the following advantages. User devices on a low-bandwidth connection can progressively render content items in a response before the entire response is received. This is advantageous because on a low-bandwidth connection, receiving an entire response can take several roundtrips, i.e., the number of roundtrips it takes a TCP connection to deliver the entire response payload.

Meanwhile, user devices on a high-bandwidth connection can receive and render both small and large responses in a single roundtrip. In other words, the subject matter described in this specification optimizes response time regardless of a user's bandwidth.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is diagram an example social messaging platform.

FIG. 2 is a flow chart of an example process for structuring responses to content requests.

FIG. 3 is a flow chart of an example process for incrementally receiving and rendering fragments of a response to a content request. FIG. 4 is a flow chart of an example process for receiving and rendering a content item that spans two or more fragments of a response.

Like reference numbers and designations in the various drawings indicate like elements.

### DETAILED DESCRIPTION

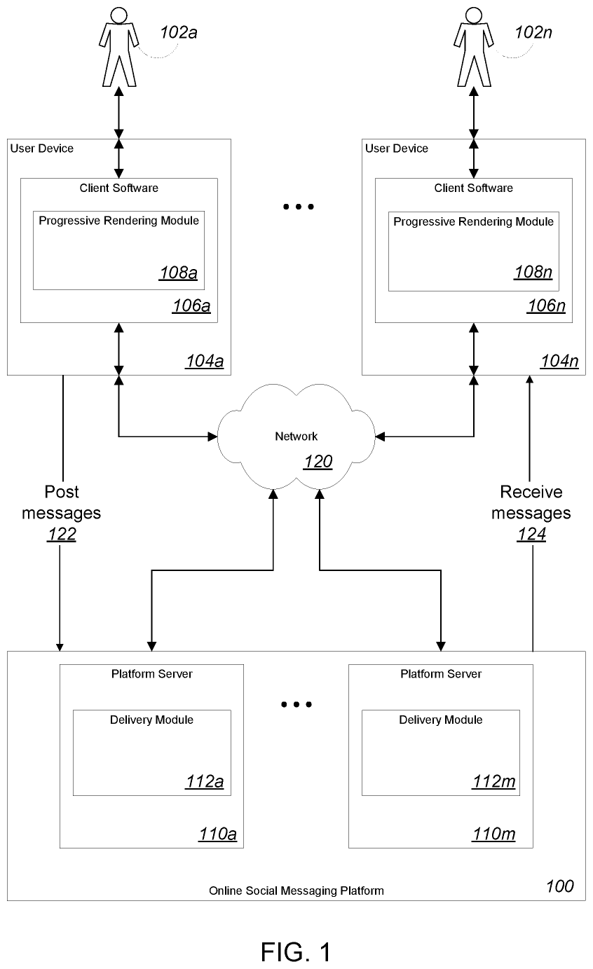

FIG. 1 illustrates an example online social messaging platform 100 and example user devices 104a-104n configured to interact with the platform over one or more wired or wireless data communication networks 120. Progressive rendering modules 108a-108n implemented in client software 106a-106n are configured, as will be described later, to incrementally receive and render content items, e.g., messages, from platform servers.

Users 102a-102n of the platform use the user devices 104a-104n, on which the client software is installed, to use the platform. Users can interact with the social messaging platform using the respective client software on their respective user devices.

A user may be an account holder of an account, or an authorized user of an account, on the platform. The platform may have millions of accounts of individuals, businesses, or other entities.

In some implementations, the platform allows use of the platform by users who are not account holders or who are not logged in to an account of the platform. If the platform allows use by such users, the platform may allow such a user to post messages or to use other functionality of the platform by associating the user with a temporary account or identifier.

A user device can be any Internet-connected device, e.g., a laptop or desktop computer, a smartphone, or an electronic tablet. The user device can be connected to the Internet through a mobile network, through an Internet service provider (ISP), or otherwise.

Each user device is configured with software, which will be referred to as a client or as client software 106a-106n, that in operation can access the platform so that a user can post and receive messages, view and curate the user's streams, and view and interact with lists of content items. On any particular user device, the client may be a web browser or an HTML (hypertext markup language) document rendered by a web browser. Or the client may be or include JavaScript code or Java code. Or the client may also be dedicated software, e.g., an installed app or installed application, that is designed to work specifically with the platform. Or the client may be or include a Short Messaging Service (SMS) interface, an instant messaging interface, an e-mail-based interface, or an API function-based interface, for example.

The client displays all or part of a display buffer, including messages and streams from the platform, in a window of a graphical user interface on a display of the user device. The display buffer is a portion of memory containing data, e.g., a bitmap, that is used to drive the display of the user device. The messages and streams in the display buffer may be in rendered bitmap form, or they may be in a partially rendered or preprocessed form that can be rendered on the fly when they are moved into a display viewport.

The graphical user interface of the client can include a scroll element or scroll functionality. A scroll element is a control that receives input from a user of the client. For example, if the user device is a desktop computer with a mouse, the user can click and drag the scroll element. If the user device is a smartphone, the user can simply swipe the screen of the user device with a finger. In response to a click and drag or a swipe, the client changes which part of the display buffer is displayed by the client.

The client includes progressive rendering modules 108a-108n. The progressive rendering modules are configured to incrementally receive and progressively render fragments of content items as those fragments are received.

The online social messaging platform is implemented on one or more computers in one or more locations that operate as one or more servers that support connections over wired or wireless networks 120 from many different kinds of user devices. The platform may have many millions of accounts, and anywhere from hundreds of thousands to millions of connections may be established or in use between clients and the platform at any given moment.

The platform and client are configured to enable users to use the platform to post messages 122 to the platform and to use the platform to receive messages 124 posted by other users.

In some implementations, the platform provides facilities for users to send messages directly to one or more other users of the platform, allowing the sender and recipients to maintain a private exchange of messages.

The platform is configured to provide content, generally messages, to a user in a home feed message stream. The messages will generally be messages from accounts the user is following, meaning that the recipient has registered to receive messages posted by the followed account, and optionally content that such accounts have engaged with, e.g., endorsed. Optionally, the platform is configured to include in a recipient user's home feed stream messages that the platform determines are likely to be of interest to the recipient, e.g., messages on topics of particular current interest, as represented by the number of messages posted on the topics by platform users, or messages posted on the topics of apparent interest to the recipient, as represented by messages the recipient has posted or engaged with, as well as selected advertisements, public service announcements, promoted content, or the like.

The platform is configured to enable users to exchange messages in real-time, i.e., with a minimal delay. The platform is also configured to enable users to respond to messages posted earlier, on the order of hours or days or even longer. The platform is configured to display posted messages to one or more other users within a short time frame so as to facilitate what can essentially be a live conversation between the users.

The platform is also configured to allow users to search for content on the platform. A search can return messages from multiple followed or public accounts that meet one or more search criteria, e.g., one or more search terms or key phrases. The platform is also configured to allow users to search for other user's accounts.

Thus, the basic messaging functionality of the platform includes at least posting new messages, providing message streams on client request, managing accounts, managing connections between accounts, messages, and streams, and receiving engagement data from clients that indicates how users of the clients have engaged with messages and possibly other content. The platform also indexes content items and access data that characterizes users' access to content and can provide the indexed data to account holders.

Generally, a message posted to the platform contains data representing content provided by the author of the message. The message may be an instance of a container data type storing the content data. The types of data that may be stored in a message include text, graphics, images, video, and computer code, e.g., uniform resource locators (URLs), for example. Messages can also include key phrases, e.g., hashtags, that can aid in categorizing messages or relating messages to topics. Messages can also include metadata that may or may not be editable by the message author account holder, depending on what the platform permits. Examples of message metadata include a time and date of authorship and a geographical location of the user device when it submitted the message. In some implementations, what metadata is provided to the platform by a client is determined by privacy settings controlled by the user or the account holder.

Messages composed by one account holder may reference other accounts, other messages, or both. For example, a message may be composed in reply to another message composed by another account. A message may also be composed by a user in reply to a message originally posted by the user. Messages may also be republications of a message composed by and received from another account. Generally, an account referenced in a message may appear as visible content in the message, e.g., the name of the account, and may also appear as metadata in the message. As a result, the referenced accounts can be interactive in the platform. For example, users may interact with account names that appear in their message stream to navigate to the message streams of those accounts. The platform also allows users to designate particular messages as private; a private message will only appear in the message streams of the composing and recipient accounts.

Generally, messages are microblog posts, which differ from e-mail messages in a number of ways, for example, in that an author of a microblog post does not necessarily need to specify, or even know, who the recipients of the message will be.

A stream is a stream of messages on the platform that meet one or more stream criteria. A stream can be defined by the stream criteria to include messages posted by one or more accounts. For example, the contents of a stream for a requesting account holder may include one or more of (i) messages composed by that account holder, (ii) messages composed by the other accounts that the requested account holder follows, (iii) messages authored by other accounts that reference the requested account holder, or (iv) messages sponsored by third parties for inclusion in the account holder's message stream. The messages of a stream may be ordered chronologically by time and date of authorship, or reverse chronologically. Streams may also be ordered in other ways, e.g., according to a computationally predicted relevance to the account holder, or according to some combination of time and relevance score.

A stream may potentially include a large number of messages. For both processing efficiency and the requesting account holder's viewing convenience, the platform generally identifies a subset of messages meeting the stream criteria to send to a requesting client once the stream is generated. The remainder of the messages in the stream are maintained in a stream repository and can be accessed by a client request.

Delivery modules 112a-112m on platform servers 110a-110m construct message streams and provide them to requesting clients, for example, through a front end server. Responding to a request for a stream, a respective delivery module either constructs the stream in real time, or accesses from a stream repository some or all of a stream that has already been generated. The delivery module stores generated streams in the stream repository. An account holder may request any of their own streams, or the streams of any other account that they are permitted to access based on security settings. If a stream includes a large number of messages, the delivery module generally identifies a subset of the messages to send to a requesting client, in which case the remainder of the messages are maintained in a stream repository and sent upon client request.

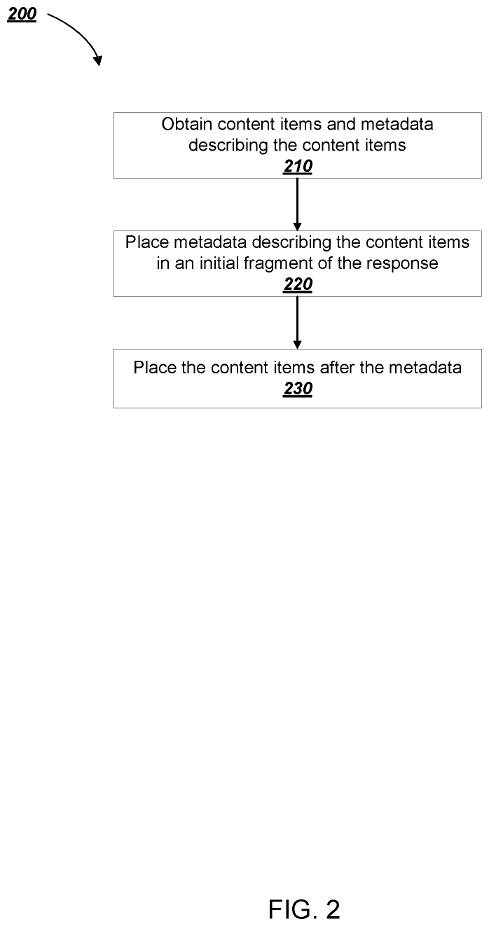

The delivery modules can structure responses to content requests in such a way that fragments of responses can be incrementally received, rendered, and displayed by the client. This process will be described in more detail in reference to FIG. 2.

FIG. 2 is a flow chart of an example process 200 for structuring responses to content requests. The process can be performed by a platform server of the online social messaging platform of FIG. 1. More specifically, the process can be performed by a delivery module on the platform server.

The delivery module obtains content items that are responsive to a content request from a client and metadata describing those content items (210).

The delivery module places metadata describing the content items in an initial fragment of the response (220). The metadata can include a sequence identifier for each content item. A sequence identifier specifies a location in a display buffer of a user device where the content item should be rendered relative to other content items. Because the metadata is in an initial fragment of the response, the client can render content items in designated places in the display buffer before the client receives all the content items in the response.

The delivery module places the content items after the metadata (230). More specifically, it places the data necessary to render each content item in the one or more data objects defining the content item or in data objects defining content items that precede the content item in the response. By structuring the data in this way, the delivery module ensures that the client receives all the data it needs to render any given content item by the time the client receives that content item. Consequently, the client can render and display one or more content items before all content items are received.

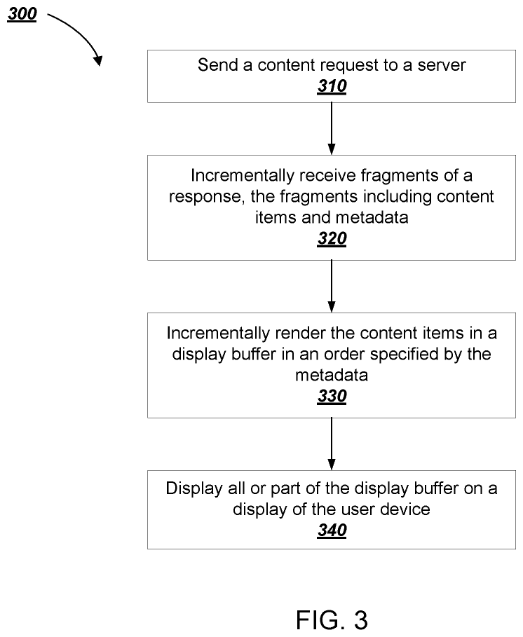

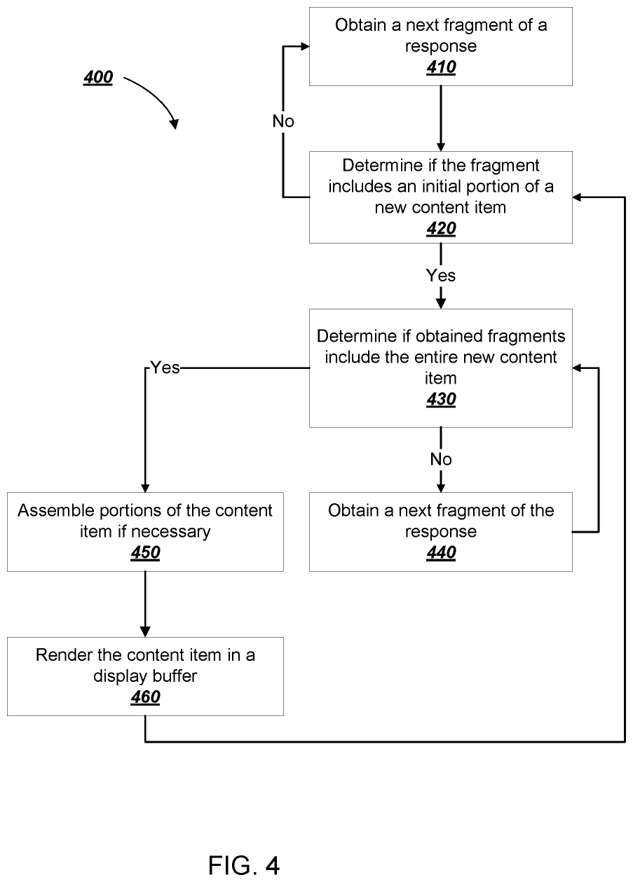

FIG. 3 is a flow chart of an example process 300 for incrementally rendering content items. The process can be performed by a client on a user device.

The client sends a request for content to a host server (310).

The host server sends a structured response to the client. In the scenario of interest, the client receives the response in multiple fragments that together constitute the entire response (320). The client obtains the fragments from a network stack on the user device, e.g., from a transport layer, before the network stack provides the entire response to the client.

The transport layer of a network stack is one of several layers of software that together provide data communication services to applications running on the user device. In particular, the transport layer implements a set of protocols that provide host-to-host communication services for applications. One example of a transport layer protocol is the Transmission Control Protocol (TCP). Another example is the User Datagram Protocol (UDP). The fragments obtained by the client are made up of one or more segments or one or more datagrams, depending on the specific protocol being used.

The fragments of the response contain content items and metadata describing the content items. Each content item is renderable for display and is defined by one or more data objects. For example, a particular content item can be defined by a JavaScript Object Notation (“JSON”) object. JSON is a text format for the serialization of structured data. It uses human-readable text to transmit data objects consisting of attribute-value pairs and array data types.

The metadata describing the content items can include, for each content item, a sequence identifier. The sequence identifier for a particular content item specifies a place in the display buffer of the content item relative to other content items in the response and relative to content items in responses that were previously rendered in the display buffer. For example, the sequence identifier might specify that a content item should be rendered “below” a first content item and “above” a second content item in the display buffer. In some implementations, the sequence identifier is based on, or is, a timestamp associated with the content item. The timestamp can indicate a time the content item was created relative to other content items. In this case, the content items can be placed in the display buffer in chronological or reverse chronological order.

Alternatively, the sequence identifier for a content item can be based on an estimate of how likely it is that a user will like or interact with the content item. For example, a platform server of the social messaging platform can determine that a particular user is more likely to like or interact with a first content item than a second content item. In such a case, the sequence identifier for the first content item might specify that it should be placed “above” the second content item so that the user will be more likely to see it, or to see it first. The host server can determine a likelihood that a user will like and interact with a particular content item by analyzing the user's previous interactions with similar content items.

The client incrementally renders the content items in the fragments into the display buffer as the fragments are obtained in an order in the display buffer determined by the metadata (330).

Each of the content items is individually renderable. In other words, the data necessary to render each content item in the response is contained in the one or more data objects defining the content item or in data found earlier in the response, e.g., earlier in a present fragment or in a previously received fragment of the response. Consequently, the client can render individual content items before it receives an entire response.

In some implementations, the client receives the metadata in an initial fragment of the response and includes, in addition to a respective sequence identifier for each content item in the response, a total count of content items in the response. With this information, the client can render the content items in the initial fragment and include in the display buffer a respective placeholder for each content item in the subsequent fragments of the response. Later, the client can replace respective placeholders when rendering content items from the subsequent fragments. The client can create the placeholders in the display buffer where the corresponding content items will appear, e.g., the places defined by the sequence identifiers of the content items.

In rendering a content item, the client generally identifies the beginning of a data object or objects defining the content item and subsequently identifies the end of the data object or objects defining the content item. In some cases, the data object or objects defining a particular content item are fully contained in a single fragment of the response. In other cases, they span two or more fragments.

Finally, the client displays all or a part of the display buffer on a display of the user device (340). In implementations in which the display buffer has placeholders, the client can display those placeholders to indicate to the user that some content items must still be rendered. The placeholders are preferably of fixed vertical height when displayed, while the incoming content items are generally of variable vertical height. As the client replaces placeholders with content items, the client can ensure that items in the viewport do not shift vertically by expanding the size of the display buffer in a direction away from the viewport. That is, if the placeholder is above the viewport, the client can cause the display buffer to expand up. If the placeholder is below the viewport, the client can cause the display buffer to expand down. The client can determine what part of the display buffer to display based on user input, e.g., based on a scrolling input to the user interface of the client.

In some implementations, the client inserts and displays a single placeholder instead of multiple adjacent placeholder.

FIG. 4 is a flow chart of an example process 400 for rendering content items that span two or more fragments of a response. The process 400 can be performed by a client running on a user device.

The client obtains a next fragment of a response (410). The client determines if the fragment includes an initial portion of a new content item (420). The client can make that determination by searching for data object identifiers in the fragment. For example, if content items are defined by JSON objects, the client can search the fragment for an opening curly brace that indicates the beginning of a JSON object. If the fragment does not include an initial portion of a new content item, the client obtains a next fragment of the response (410).

If the fragment does include an initial portion of a new content item, the client determines if obtained fragment, i.e., the current fragment and previously obtained fragments, include the entire new content item (430). That is, the client determines if it has obtained all portions of the new content item. The client can search the fragment for data object identifiers to make this determination.

If the client determines that it has not obtained all portions of the new content item, it obtains a next fragment of the response (440) and again determines if that next fragment and previously obtained fragments include the entire new content item (430). Because content items can span two or more fragments of a response, the client may repeat this process several times.

If the client determines that it has obtained all portions of the new content item, it assembles those portions (450). The client can assemble the portions as it receives them, or it can assemble them all at once after it has received all portions. In some cases, the content item may be fully contained in a single fragment of the response. In such cases, no assembly is required.

The client renders the assembled content item in a display buffer on the user device (460). Thereafter, the client determines if the current fragment includes any portion of a new content item (420), since a single fragment can contain multiple content items. If not, the client obtains a next fragment of the response (410).

In some cases, while the client incrementally receives and renders data, a response may partially fail. For example, a response having one hundred content items might fail after the client has received only twenty content items. Such a failure can occur, for example, if the transport layer protocol is UDP. UDP does not require communication channels and is thus susceptible to unreliability of the underlying network.

When this occurs, in some implementations, an error is shown inline, i.e., an error is displayed where the remaining eighty content items would have otherwise been displayed. user of the client can interact with that error message in the graphical user interface to retry loading the remaining eighty content items.

If the client receives a malformed content item, e.g., if the client receives a content item with missing data, the client can silently drop the content.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method performed by client software of a social messaging platform running on a user device, the method comprising:

sending a content request to a server comprising one or more computers and one or more storage devices, the server configured to implement the social messaging platform;

receiving a response to the content request from the server incrementally in multiple fragments from a transport layer of a network stack on the user device, wherein the multiple fragments constitute the entire response, wherein the response includes content items and metadata describing the content items, and wherein each content item is renderable and defined by one or more data objects;

incrementally rendering, into a display buffer, the content items in the fragments as the fragments are received, including placing the content items in the display buffer in an order determined by the metadata, the display buffer being a data structure in a memory of the user device; and

displaying all or a part of the display buffer on a display of the user device.

Embodiment 2 is the method of embodiment 1, wherein the client software is a stand-alone app or a JavaScript program running in a web browser installed on the user device.

Embodiment 3 is the method of any of embodiments 1-2, wherein the metadata describing the content items includes, for each content item, a sequence identifier that specifies a place in the display buffer of the content item relative to other content items in the response and relative to content items in responses previously rendered in the display buffer.

Embodiment 4 is the method of embodiment 3, wherein a sequence identifier for a respective content item corresponds to a time the content item was created relative to other content items.

Embodiment 5 is the method of any of embodiments 1-4, wherein the metadata is received in an initial fragment of the response and includes a total count of content items in the response, and wherein the method further comprises:

rendering in the display buffer the content items in the initial fragment and including in the display buffer a respective placeholder for each content item in subsequent fragments of the response; and

replacing the respective placeholders when rendering the content items in the subsequent fragments.

Embodiment 6 is the method of embodiment 5, wherein the metadata further includes, for each content item, a sequence identifier, and wherein a respective placeholder is created in a place in the display buffer specified by the sequence identifier of its corresponding content item.

Embodiment 7 is the method of any of embodiments 1-6, wherein incrementally rendering the content items in the fragments as the fragments are received comprises:

determining that a first fragment includes only an initial portion of a particular content item;

receiving a second fragment that includes the rest of the particular content item;

assembling the initial portion and the rest of the particular content item; and

rendering the assembled content item in the display buffer.

Embodiment 8 is the method of embodiment 7, wherein the one or more data objects are JSON objects, and wherein incrementally rendering the content items in the fragments as the fragments are received, comprises, for each content item:

identifying the beginning of a JSON object defining the content item; and

identifying the end of the JSON object defining the content item.

Embodiment 9 is the method of any of embodiments 1-8, wherein each of the fragments of the response comprises one or more transport layer segments provided by a transport layer protocol to the client software.

Embodiment 10 is the method of any of embodiments 1-9, wherein, in each response, data necessary to render each content item in the response is contained in the one or more data objects defining the content item or in one or more data objects defining content items previously received in the response.

Embodiment 11 is the method of any of embodiments 1-10, wherein the server is a remote server.

Embodiment 12 is a system comprising:

a server comprising one or more computers and one or more storage devices, the server configured to implement a social messaging platform;

a user device; and

client software of the social messaging platform running on the user device,

wherein the client software is configured to perform the method of any one of embodiments 1-11.

Embodiment 13 is one or more computer storage media storing instructions that are operable, when executed by the one or more computers, to cause the one or more computers to perform the method of any one of embodiments 1-11.

Embodiment 14 is a system comprising:

one or more computers and one or more storage devices configured to implement a social messaging platform, the one or more storage devices storing instructions that, when executed by the one or more computers, cause the one or more computers to perform operations comprising:
receiving a content request from client software of the social messaging platform, the client software running on a user device;
obtaining (i) content items corresponding to the content request, (ii) metadata describing the content items, and (iii) data necessary to render the content items, wherein the metadata describing the content items includes, for each content item, a sequence identifier that specifies a location in a display buffer of the user device where the content item should be rendered relative to other content items;
generating a response to the content request, including:
   placing the metadata in an initial fragment of the response, and
   placing the data necessary to render each content item in one or more data objects defining the content item or in one or more data objects defining a content item that precedes the content item in the response; and
sending the response to the client software.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. (canceled)

2. A method performed by client software of a social messaging platform running on a user device, the method comprising:
sending a content request to a server comprising one or more computers and one or more storage devices, the server implementing the social messaging platform;
while a) a network stack on the user device is receiving fragments from a plurality of fragments that together form a response to the content request from the server and b) before the network stack receives a last fragment in the plurality of fragments:
incrementally retrieving, by the client software and from a transport layer of the network stack, multiple fragments of the plurality of fragments of the response, wherein the response includes content items and metadata describing the content items, the metadata identifies, for each of the content items, a location at which the content item is placed into a display buffer, the location at which the content item is placed into the display buffer corresponds to a position where the content item will be displayed on a display, and each content item is renderable and defined by one or more data objects;
incrementally rendering, into a display buffer, the content items in the fragments as the fragments are incrementally retrieved from the transport layer, including placing the content items in the display buffer at the location identified by the metadata, the display buffer being a data structure in a memory of the user device;
displaying all or a part of the display buffer on the display of the user device; and
after i) the network stack has received, from the server, all fragments from the plurality of fragments that together form the response to the content request and ii) the client software incrementally obtained the multiple fragments from the plurality of fragments of the response:
receiving, by the client software and from the network stack, the response that includes all fragments from the plurality of fragments including the multiple fragments that were incrementally retrieved.

3. The method of claim 2, wherein the metadata describing the content items includes, for each content item, a sequence identifier that specifies the location in the display buffer of the content item relative to other content items in the response and relative to content items in responses previously rendered in the display buffer.

4. The method of claim 3, wherein the sequence identifier for each content item corresponds to a time the content item was created on another system relative to other content items.

5. The method of claim 2, wherein the metadata is received in an initial fragment of the response and includes a total count of content items in the response, and wherein the operations further comprise:
while the user device is receiving the response and before receiving subsequent fragments from the plurality of fragments of the response, rendering in the display buffer the content items in the initial fragment and including in the display buffer a respective placeholder for each content item in the subsequent fragments of the response; and
in response to obtaining a subsequent fragment from the subsequent fragments, replacing a respective placeholder when rendering a content item in the subsequent fragment.

6. The method of claim 5, wherein:
the metadata further includes, for each content item, a sequence identifier; and
the operations comprising creating, for a content item, a respective placeholder in a respective location in the display buffer specified by the respective sequence identifier.

7. The method of claim 2, wherein incrementally rendering the content items in the fragments as the fragments are received comprises:
determining that a first fragment includes only an initial portion of a particular content item;
receiving a second fragment that includes the rest of the particular content item;
assembling the initial portion and the rest of the particular content item; and
rendering the assembled content item in the display buffer.

8. The method of claim 2, wherein each of the fragments of the response comprises one or more transport layer segments provided by a transport layer protocol to the client software.

9. One or more non-transitory computer readable storage media implementing client software, the computer readable storage media storing instructions that are operable, when executed by one or more computers, to cause the one or more computers to perform operations comprising:
sending, for a client software, a content request to a server comprising one or more computers and one or more storage devices, the server implementing a social messaging platform;
while a) a network stack on the one or more computers are receiving, from the server, fragments from a plurality of fragments that together form a single response to the client software's content request and b) before the network stack receives a last fragment in a plurality of fragments, which plurality of fragments together form the response:
incrementally obtaining multiple fragments of the plurality of fragments of the single response from a transport layer of the network stack, wherein:
the single response includes i) content items and metadata describing the content items, ii) all fragments from the plurality of fragments including the incrementally obtained multiple fragments, and iii) is provided by the network stack to the client software in response to the content request,
the metadata identifies, for each of the content items, a location at which the content item is placed into a display buffer,
the location at which the content item is placed into the display buffer corresponds to a position where the content item will be displayed on a display, and
each content item is renderable and defined by one or more data objects;
incrementally rendering, into a display buffer, the content items in the fragments as the fragments are obtained from the transport layer, including placing the content items in the display buffer at the location identified by the metadata, the display buffer being a data structure in a memory of the one or more computers; and
displaying all or a part of the display buffer on the display of the one or more computers.

10. The one or more non-transitory computer readable storage media of claim 9, wherein the single response includes all fragment from the plurality of fragments that include the obtained multiple fragments and other fragments that have not been obtained.

11. The one or more non-transitory computer readable storage media of claim 9, wherein the metadata describing the content items includes, for each content item, a sequence identifier that specifies the location in the display buffer of the content item relative to other content items in the response and relative to content items in responses previously rendered in the display buffer.

12. The one or more non-transitory computer readable storage media of claim 11, wherein the sequence identifier for each content item corresponds to a time the content item was created on another system relative to other content items.

13. The one or more non-transitory computer readable storage media of claim 9, wherein the metadata is received in an initial fragment of the response and includes a total count of content items in the response, and wherein the operations further comprise:
while the user device is receiving the response and before receiving subsequent fragments from the plurality of fragments of the response, rendering in the display buffer the content items in the initial fragment and including in the display buffer a respective placeholder for each content item in the subsequent fragments of the response; and
in response to obtaining a subsequent fragment from the subsequent fragments, replacing a respective placeholder when rendering a content item in the subsequent fragment.

14. The one or more non-transitory computer readable storage media of claim 13, wherein:
the metadata further includes, for each content item, a sequence identifier; and
the operations comprising creating, for a content item, a respective placeholder in a respective location in the display buffer specified by the respective sequence identifier.

15. The one or more non-transitory computer readable storage media of claim 9, wherein incrementally rendering the content items in the fragments as the fragments are received comprises:
determining that a first fragment includes only an initial portion of a particular content item;
receiving a second fragment that includes the rest of the particular content item;
assembling the initial portion and the rest of the particular content item; and
rendering the assembled content item in the display buffer.

16. The one or more non-transitory computer readable storage media of claim 9, wherein each of the fragments of the response comprises one or more transport layer segments provided by a transport layer protocol to the client software.

17. A system comprising one or more computers and one or more storage devices on which are stored instructions that are operable, when executed by the one or more computers, to cause the one or more computers to perform operations comprising:
sending a content request to a server comprising one or more computers and one or more storage devices, the server implementing the social messaging platform;
while a) a network stack on the user device is receiving fragments from a plurality of fragments that together form a response to the content request from the server and b) before the network stack receives a last fragment in the plurality of fragments:
incrementally retrieving, by the client software and from a transport layer of the network stack, multiple fragments of the plurality of fragments of the response, wherein the response includes content items and metadata describing the content items, the metadata identifies, for each of the content items, a location at which the content item is placed into a display buffer, the location at which the content item is placed into the display buffer corresponds to a position where the content item will be displayed on a display, and each content item is renderable and defined by one or more data objects;
incrementally rendering, into a display buffer, the content items in the fragments as the fragments are incrementally retrieved from the transport layer, including placing the content items in the display buffer at the location identified by the metadata, the display buffer being a data structure in a memory of the user device;
displaying all or a part of the display buffer on the display of the user device; and
after i) the network stack has received, from the server, all fragments from the plurality of fragments that together form the response to the content request and ii) the client software incrementally obtained the multiple fragments from the plurality of fragments of the response:
receiving, by the client software and from the network stack, the response that includes all fragments from the plurality of fragments including the multiple fragments that were incrementally retrieved.

18. The system of claim 17, wherein the metadata describing the content items includes, for each content item, a sequence identifier that specifies the location in the display buffer of the content item relative to other content items in the response and relative to content items in responses previously rendered in the display buffer.

19. The system of claim 18, wherein the sequence identifier for each content item corresponds to a time the content item was created on another system relative to other content items.

20. The system of claim 17, wherein the metadata is received in an initial fragment of the response and includes a total count of content items in the response, and wherein the operations further comprise:
while the user device is receiving the response and before receiving subsequent fragments from the plurality of fragments of the response, rendering in the display buffer the content items in the initial fragment and including in the display buffer a respective placeholder for each content item in the subsequent fragments of the response; and
in response to obtaining a subsequent fragment from the subsequent fragments, replacing a respective placeholder when rendering a content item in the subsequent fragment.

21. The system of claim 20, wherein:
the metadata further includes, for each content item, a sequence identifier; and
the operations comprising creating, for a content item, a respective placeholder in a respective location in the display buffer specified by the respective sequence identifier.

22. The system of claim 17, wherein incrementally rendering the content items in the fragments as the fragments are received comprises:
determining that a first fragment includes only an initial portion of a particular content item;
receiving a second fragment that includes the rest of the particular content item;
assembling the initial portion and the rest of the particular content item; and
rendering the assembled content item in the display buffer.

23. The system of claim 17, wherein each of the fragments of the response comprises one or more transport layer segments provided by a transport layer protocol to the client software.
